(19) United States
(12) Patent Application Publication
(10) Pub. No.: US 2022/0307981 A1
(43) Pub. Date: Sep. 29, 2022

(54) METHOD AND DEVICE FOR DETECTING A FLUID BY A COMPUTER VISION APPLICATION

(71) Applicant: BASF Coatings GmbH, Münster (DE)

(72) Inventors: Yunus Emre KURTOGLU, Southfield, MI (US); Matthew Ian CHILDERS, Southfield, MI (US)

(21) Appl. No.: 17/616,937

(22) PCT Filed: Jun. 5, 2020
(86) PCT No.: PCT/EP2020/065746

§ 371 Date: Dec. 6, 2021

Related U.S. Application Data
(63) Continuation of application No. 62/858,353, filed on Jun. 7, 2019.

(30) Foreign Application Priority Data
Jun. 7, 2019 (EP) 19179159.9

(51) Int. Cl. G01N 21/64; G01M 3/38; G01M 3/22; G06V 10/143

(52) U.S. Cl. CPC G01N 21/645; G01M 3/38; G01M 3/22; G06V 10/143; G01N 2021/6417

(57) ABSTRACT

Described herein are a device and a method for recognizing and monitoring a fluid in a system and/or in surroundings of the system via a computer vision application, the device including at least the following components:
at least one luminescent dye, each luminescent dye having a dye specific reflectance and luminescence spectral pattern and being configured to be added to the fluid,
a light source which is composed of at least two illuminants and which is configured to illuminate a scene which includes the system and/or the surroundings of the system, by switching between the at least two illuminants, where at least one of the two illuminants is based on at least one solid-state system,
a sensor which is configured to measure radiance data of the scene when the scene is illuminated by the light source, and
a data processing unit.

The present invention refers to a method and a device for detecting and/or monitoring fluids by a computer vision application.

### BACKGROUND

Computer vision is a field in rapid development due to abundant use of electronic devices capable of collecting information about their surroundings via sensors such as cameras, distance sensors such as LiDAR or radar, and depth camera systems based on structured light or stereo vision to name a few. These electronic devices provide raw image data to be processed by a computer processing unit and consequently develop an understanding of an environment or a scene using artificial intelligence and/or computer assistance algorithms. There are multiple ways how this understanding of the environment can be developed. In general, 2D or 3D images and/or maps are formed, and these images and/or maps are analyzed for developing an understanding of the scene and the objects in that scene. One prospect for improving computer vision is to measure the components of the chemical makeup of objects in the scene. While shape and appearance of objects in the environment acquired as 2D or 3D images can be used to develop an understanding of the environment, these techniques have some shortcomings.

One challenge in computer vision field is being able to identify as many objects as possible within each scene with high accuracy and low latency using a minimum amount of resources in sensors, computing capacity, light probe etc. The object identification process has been termed remote sensing, object identification, classification, authentication or recognition over the years. In the scope of the present disclosure, the capability of a computer vision system to identify an object in a scene is termed as “object recognition”. For example, a computer analyzing a picture and identifying/labelling a ball in that picture, sometimes with even further information such as the type of a ball (basketball, soccer ball, baseball), brand, the context, etc. fall under the term “object recognition”.

Generally, techniques utilized for recognition of an object in computer vision systems can be classified as follows:

Technique 1: Physical tags (image based): Barcodes, QR codes, serial numbers, text, patterns, holograms etc.

Technique 2: Physical tags (scan/close contact based): Viewing angle dependent pigments, upconversion pigments, metachromics, colors (red/green), luminescent materials.

Technique 3: Electronic tags (passive): RFID tags, etc. Devices attached to objects of interest without power, not necessarily visible but can operate at other frequencies (radio for example).

Technique 4: Electronic tags (active): wireless communications, light, radio, vehicle to vehicle, vehicle to anything (X), etc. Powered devices on objects of interest that emit information in various forms.

Technique 5: Feature detection (image based): Image analysis and identification, i.e. two wheels at certain distance for a car from side view; two eyes, a nose and mouth (in that order) for face recognition etc. This relies on known geometries/shapes.

Technique 6: Deep learning/CNN based (image based): Training of a computer with many of pictures of labeled images of cars, faces etc. and the computer determining the features to detect and predicting if the objects of interest are present in new areas. Repeating of the training procedure for each class of object to be identified is required.

Technique 7: Object tracking methods: Organizing items in a scene in a particular order and labeling the ordered objects at the beginning. Thereafter following the object in the scene with known color/geometry/3D coordinates. If the object leaves the scene and re-enters, the “recognition” is lost.

In the following, some shortcomings of the above-mentioned techniques are presented.

Technique 1: When an object in the image is occluded or only a small portion of the object is in the view, the barcodes, logos etc. may not be readable. Furthermore, the barcodes etc. on flexible items may be distorted, limiting visibility. All sides of an object would have to carry large barcodes to be visible from a distance otherwise the object can only be recognized in close range and with the right orientation only. This could be a problem for example when a barcode on an object on the shelf at a store is to be scanned. When operating over a whole scene, technique 1 relies on ambient lighting that may vary.

Technique 2: Upconversion pigments have limitations in viewing distances because of the low level of emitted light due to their small quantum yields. They require strong light probes. They are usually opaque and large particles limiting options for coatings. Further complicating their use is the fact that compared to fluorescence and light reflection, the upconversion response is slower. While some applications take advantage of this unique response time depending on the compound used, this is only possible when the time of flight distance for that sensor/object system is known in advance. This is rarely the case in computer vision applications. For these reasons, anti-counterfeiting sensors have covered/dark sections for reading, class 1 or 2 lasers as probes and a fixed and limited distance to the object of interest for accuracy.

Similarly viewing angle dependent pigment systems only work in close range and require viewing at multiple angles. Also, the color is not uniform for visually pleasant effects. The spectrum of incident light must be managed to get correct measurements. Within a single image/scene, an object that has angle dependent color coating will have multiple colors visible to the camera along the sample dimensions.

Color-based recognitions are difficult because the measured color depends partly on the ambient lighting conditions. Therefore, there is a need for reference samples and/or controlled lighting conditions for each scene. Different sensors will also have different capabilities to distinguish different colors, and will differ from one sensor type/maker to another, necessitating calibration files for each sensor.

Luminescence based recognition under ambient lighting is a challenging task, as the reflective and luminescent components of the object are added together. Typically luminescence based recognition will instead utilize a dark measurement condition and a priori knowledge of the excitation region of the luminescent material so the correct light probe/source can be used.

Technique 3: Electronic tags such as RFID tags require the attachment of a circuit, power collector, and antenna to the item/object of interest, adding cost and complication to the design. RFID tags provide present or not type information but not precise location information unless many sensors over the scene are used.

Technique 4: These active methods require the object of interest to be connected to a power source, which is cost-prohibitive for simple items like a soccer ball, a shirt, or a box of pasta and are therefore not practical.

Technique 5: The prediction accuracy depends largely on the quality of the image and the position of the camera within the scene, as occlusions, different viewing angles, and the like can easily change the results. Logo type images can be present in multiple places within the scene (i.e., a logo can be on a ball, a T-shirt, a hat, or a coffee mug) and the object recognition is by inference. The visual parameters of the object must be converted to mathematical parameters at great effort. Flexible objects that can change their shape are problematic as each possible shape must be included in the database. There is always inherent ambiguity as similarly shaped objects may be misidentified as the object of interest.

Technique 6: The quality of the training data set determines the success of the method. For each object to be recognized/classified many training images are needed. The same occlusion and flexible object shape limitations as for Technique 5 apply. There is a need to train each class of material with thousands or more of images.

Technique 7: This technique works when the scene is pre-organized, but this is rarely practical. If the object of interest leaves the scene or is completely occluded the object could not be recognized unless combined with other techniques above.

Apart from the above-mentioned shortcomings of the already existing techniques, there are some other challenges worth mentioning. The ability to see a long distance, the ability to see small objects or the ability to see objects with enough detail all require high resolution imaging systems, i.e. high-resolution camera, LiDAR, radar etc. The high-resolution needs increase the associated sensor costs and increase the amount of data to be processed.

For applications that require instant responses like autonomous driving or security, the latency is another important aspect. The amount of data that needs to be processed determines if edge or cloud computing is appropriate for the application, the latter being only possible if data loads are small. When edge computing is used with heavy processing, the devices operating the systems get bulkier and limit ease of use and therefore implementation.

Thus, a need exists for systems and methods that are suitable for improving object recognition capabilities for computer vision applications. In particular, recognition or sensing of molecules that are not part of a solid surface pose unique challenges since the computer vision systems utilizing the visible portions of electromagnetic spectrum do not have such capabilities but rely on geometry, 2D or 3D information structures that are more or less static. For fluids that do not present a fixed boundary condition, such as gases and liquids, these shape-based recognition methods and sensing techniques come short.

### SUMMARY OF THE INVENTION

Therefore, it was an object of the present disclosure to provide a device and a method that enable the recognition and the monitoring of fluids, e.g. gases and liquids, i.e. of molecules present without a solid-state boundary.

The present disclosure provides a device and a method with the features of the independent claims. Embodiments are subject of the dependent claims and the description and drawings.

According to claim 1, a device is provided for recognizing and monitoring a fluid in and/or in the surroundings of a system via a computer vision application, the device comprising at least the following components:
at least one luminescent dye, each luminescent dye having a dye specific reflectance and luminescence spectral pattern and being configured to be added to the fluid,
a device that is configured to add, e.g. admix, the at least one luminescent dye to the fluid,
a light source which is composed of at least two illuminants and which is configured to illuminate a scene including the system and/or the surroundings of the system, particularly under ambient lighting conditions, by switching between the at least two illuminants, wherein at least one of the two illuminants is based on at least one solid-state system,
a sensor which is configured to measure radiance data of the scene including the system when the scene is illuminated by the light source,
a data processing unit which is configured to inspect whether the dye specific luminescence spectral pattern is detectable out of the radiance data of the scene when the scene is illuminated by the light source, and, in the case that the dye specific luminescence spectral pattern can be detected out of the radiance data, to identify the fluid the dye has been added to.

Within the scope of the present disclosure the terms “fluorescent” and “luminescent” are used synonymously. The same applies to the terms “fluorescence” and “luminescence”. The term “fluid” comprises gases and liquids, i. e. a fluid can be a gas or a liquid.

The device can be particularly used for detecting a leak within the system. In that case the system uses the fluid as operating medium which is to be carried continuously through (pipes of) the system. According to that embodiment, the device further comprises a controller which is configured to run the system to circulate the dye throughout the system after the dye has been added to the fluid.

According to said possible embodiment, the device is configured to be used for monitoring the system for leaks via a computer vision application, wherein the system uses the fluid as operating medium which is carried continuously through the system, wherein the data processing unit is further configured to identify a leak of the system, in the case that the dye specific luminescence spectral pattern can be detected out of the radiance data.

Thus, a device is provided for monitoring a system for leaks via a computer vision application, the system using a fluid as operating medium which is to be carried continuously through (pipes of) the system, the device comprising at least the following components:
at least one luminescent dye, each luminescent dye having a dye specific reflectance and luminescence spectral pattern and being configured to be added to the fluid,
a controller which is configured to run the system to circulate the dye throughout the system,
a light source which is composed of at least two illuminants and which is configured to illuminate a scene including the system and/or surroundings of the system, particularly under ambient lighting conditions, by switching between the at least two illuminants, wherein at least one of the two illuminants is based on at least one solid-state system,
a sensor which is configured to measure radiance data of the scene including the system and/or the surroundings of the system when the scene is illuminated by the light source,
a data processing unit which is configured to inspect whether the dye specific luminescence spectral pattern is detectable out of the radiance data of the scene when the scene is illuminated by the light source, and, in the case that the dye specific luminescence spectral pattern can be detected out of the radiance data, to identify a leak of the system.

Within the scope of the present disclosure, a fluid is to be understood as an object without a solid-state boundary, i.e. a gas or a liquid. The fluid consists of molecules that are not part of a solid surface and do not present a fixed boundary condition.

Thus, a liquid in a glass, bowl, plate, cup or in a transparent glass or plastic container may be monitored.

According to a further embodiment of the proposed device, the device further comprises an output unit which is configured to perform a predefined action, in the case that the dye specific luminescence spectral pattern can be extracted/detected out of the radiance data. Thus, the device can output a notification of the identified fluid, particularly of a leak of the system in the case the device is used for leak detection, and/or it may stop the leaking system and/or start any other preventative action, such as open a window, turn off electricity, etc.

According to still a further embodiment, the device comprises a plurality of different dyes, the different dyes having different dye specific reflectance and/or luminescence spectral patterns and being configured to be added to the fluid in different fluid paths within the system, thus enabling, in the case that one of the dye specific luminescence spectral patterns can be detected/extracted out of the radiance data, a localisation of the identified fluid and, thus, of the identified leak in the case the device is used for leak detection.

According to a further embodiment the device comprises a data storage unit with luminescence spectral patterns together with appropriately assigned respective dyes, wherein the data processing unit is configured to identify the dye specific luminescence spectral pattern of the at least one dye by matching the extracted dye specific luminescence spectral pattern with the luminescence spectral patterns stored in the data storage unit using any number of matching algorithms between the extracted dye specific luminescence spectral pattern and the stored luminescence spectral patterns. The matching algorithms may be chosen from the group comprising at least one of: lowest root mean squared error, lowest mean absolute error, highest coefficient of determination, matching of maximum wavelength value.

The sensor is generally an optical sensor with photon counting capabilities. More specifically, it may be a monochrome camera, or an RGB camera, or a multispectral camera, or a hyperspectral camera. The sensor may be a combination of any of the above, or the combination of any of the above with a tuneable or selectable filter set, such as, for example, a monochrome sensor with specific filters. The sensor may measure a single pixel of the scene, or measure many pixels at once. The optical sensor may be configured to count photons in a specific range of spectrum, particularly in more than three bands. It may be a camera with multiple pixels for a large field of view, particularly simultaneously reading all bands or different bands at different times.

A multispectral camera captures image data within specific wavelength ranges across the electromagnetic spectrum. The wavelengths may be separated by filters or by the use of instruments that are sensitive to particular wavelengths, including light from frequencies beyond the visible light range, i.e. infrared and ultra-violet. Spectral imaging can allow extraction of additional information the human eye fails to capture with its receptors for red, green and blue. A multispectral camera measures light in a small number (typically 3 to 15) of spectral bands. A hyperspectral camera is a special case of spectral camera where often hundreds of contiguous spectral bands are available.

The light source may be a switchable light source with two illuminants each comprised of one or more LEDs and with a short switchover time between the two illuminants. The light source is preferably chosen as being capable of switching between at least two different illuminants. Three or more illuminants may be required for some methods. The total combination of illuminants is referred to as the light source. One method of doing this is to create illuminants from different wavelength light emitting diodes (LEDs). LEDs may be rapidly switched on and off, allowing for fast switching between illuminants. Fluorescent light sources with different emissions may also be used. Incandescent light sources with different filters may also be used. The light source may be switched between illuminants at a rate that is not visible to the human eye. Sinusoidal like illuminants may also be created with LEDs or other light sources, which is useful for some of the proposed computer vision algorithms.

The sensor which is configured to measure the radiance data of the scene is linked and synchronized with the switching of the light source between illuminants. According to a further embodiment of the proposed device, the sensor is synchronized to the switching of the light source to only issue at one time the radiance data from the scene under one of the at least two illuminants. That means that the sensor may be configured to only capture information during the time period one illuminant is active. It may be configured to capture/measure information during one or more illuminants being active and use various algorithms to calculate and issue the radiance for a subset of the illuminants. It may be configured to capture the scene radiance at a particular period before, after or during the activation of the light source and may last longer or shorter than the light pulse. That means that the sensor is linked to the switching, but it does not necessarily need to capture radiance data during the time period only one illuminant is active. This procedure could be advantageous in some systems to reduce noise, or due to sensor timing limitations.

It is possible that the sensor is synchronized to the light source and that the sensor tracks the illuminants' status during the sensor integration time. The spectral changes of the light source are managed by a control unit via a network, working in sync with the sensor's integration times. Multiple light sources connected to the network can be synced to have the same temporal and spectral change frequencies amplifying the effect.

Generally, at least the light source, the sensor, the data processing unit and the data storage unit (the database) are networked among each other via respective communicative connections. Thus, each of the communicative connections between the different components of the monitoring device may be a direct connection or an indirect connection, respectively. Each communicative connection may be a wired or a wireless connection. Each suitable communication technology may be used. The data processing unit, the sensor, the data storage unit, the light source, each may include one or more communications interfaces for communicating with each other. Such communication may be executed using a wired data transmission protocol, such as fiber distributed data interface (FDDI), digital subscriber line (DSL), Ethernet, asynchronous transfer mode (ATM), or any other wired transmission protocol. Alternatively, the communication may be wirelessly via wireless communication networks using any of a variety of protocols, such as General Packet Radio Service (GPRS), Universal Mobile Telecommunications System (UMTS), Code Division Multiple Access (CDMA), Long Term Evolution (LTE), wireless Universal Serial Bus (USB), and/or any other wireless protocol. The respective communication may be a combination of a wireless and a wired communication.

The data processing unit may include or may be in communicative connection with one or more input units, such as a touch screen, an audio input, a movement input, a mouse, a keypad input and/or the like. Further the data processing unit may include or may be in communication, i. e. in communicative connection with one or more output units, such as an audio output, a video output, screen/display output, and/or the like.

Embodiments of the invention may be used with or incorporated in a computer system that may be a standalone unit or include one or more remote terminals or devices in communication with a central computer, located, for example, in a cloud, via a network such as, for example, the Internet or an intranet. As such, the computing device described herein and related components may be a portion of a local computer system or a remote computer or an online system or a combination thereof. The database and software described herein may be stored in computer internal memory or in a non-transitory computer readable medium.

Within the scope of the present disclosure the database may be part of the data storage unit or may represent the data storage unit itself. The terms “database” and “data storage unit” are used synonymously.

According to a further aspect, embodiments of the invention are directed to a method for recognizing and monitoring a fluid in a system and/or in surroundings of the system via a computer vision application, the method comprising at least the following steps:
adding a luminescent dye to the fluid, the luminescent dye having a dye specific reflectance and luminescence spectral pattern,
illuminating a scene including the system and/or surroundings of the system, preferably under ambient lighting conditions, with an additional light source which is composed of at least two illuminants, by switching between the at least two illuminants, wherein at least one of the two illuminants is based on at least one solid-state system,
measuring, by means of a sensor, radiance data of the scene when the scene is illuminated by the light source,
inspecting, by a data processing unit, whether the dye specific luminescence spectral pattern is detectable out of the radiance data of the scene, and
in the case that the dye specific luminescence spectral pattern can be detected out of the radiance data, identifying, by the data processing unit, the fluid.

In another aspect, embodiments of the invention are directed to a method for monitoring a system for leaks via a computer vision application, the system using a fluid as operating medium, e. g. as coolant, which is to be carried continuously through (pipes of) the system, the method comprising at least the following steps:
adding a luminescent dye to the fluid, the luminescent dye having a dye specific reflectance and luminescence spectral pattern,
running the system to circulate the dye together with the fluid throughout the system,
illuminating a scene including the system and/or surroundings of the system, preferably under ambient lighting conditions, with an additional light source which is composed of at least two illuminants, by switching between the at least two illuminants, wherein at least one of the two illuminants is based on at least one solid-state system,
measuring, by means of a sensor, radiance data of the scene when the scene is illuminated by the light source,
inspecting, by a data processing unit, whether the dye specific luminescence spectral pattern is extractable/detectable out of the radiance data of the scene, and
in the case that the dye specific luminescence spectral pattern can be extracted/detected out of the radiance data, identifying, by the data processing unit, a leak of the system.

According to one embodiment of the proposed method, the method further comprises providing a data storage unit with luminescence spectral patterns together with appropriately assigned respective dyes, and identifying the dye specific luminescence spectral pattern of the at least one dye by matching the extracted dye specific luminescence spectral pattern with the luminescence spectral patterns stored in the data storage unit using any number of matching algorithms between the extracted dye specific luminescence spectral pattern and the stored luminescence spectral patterns. The matching algorithms may be chosen from the group comprising at least one of: lowest root mean squared error, lowest mean absolute error, highest coefficient of determination, matching of maximum wavelength value.

In a further embodiment, the method further comprises performing a predefined action, e. g. outputting, in the case that the dye specific luminescence spectral pattern can be extracted out of the radiance data, a notification of the identified leak of the system via an output unit. Additionally or alternatively, the leaking system can be stopped and/or any other preventative action, such as opening a window or turning off electricity can be performed.

In still a further embodiment of the proposed method, a plurality of different dyes is provided, the different dyes having different dye specific reflectance and luminescence spectral patterns, and different dyes are added to the fluid in different fluid paths within the system, thus enabling, in the case that one of the dye specific luminescence spectral patterns can be extracted out of the radiance data, a localisation of the fluid and, thus, of the identified leak, in the case the method is performed for leak detection.

The light source may be chosen as a switchable light source with two illuminants each comprised of one or more LEDs and with a short switchover time between the two illuminants.

In another aspect, embodiments of the invention are directed to a computer program product having instructions for recognizing and monitoring a fluid in a system and/or in surroundings of the system via a computer vision application, wherein the instructions are executable by a computer, particularly by a data processing unit as described before, and, when executed, cause a machine to:
add a luminescent dye to the fluid, the luminescent dye having a dye specific reflectance and luminescence spectral pattern,
illuminate a scene which includes the system and/or the surroundings of the system, preferably under ambient lighting conditions, with an additional light source which is composed of at least two illuminants, by switching between the at least two illuminants, wherein at least one of the two illuminants is based on at least one solid-state system,
measure, by means of a sensor, radiance data of the scene when the scene is illuminated by the light source,
determine/inspect whether the dye specific luminescence spectral pattern is detectable/extractable out of the radiance data of the scene, and
identify the fluid in the case that the dye specific luminescence spectral pattern can be detected/extracted out of the radiance data.

In another aspect, embodiments of the invention are directed to a computer program product having instructions for monitoring a system for leaks via a computer vision application, the system using a fluid as operating medium, e. g. as coolant, which is to be carried continuously through (pipes of) the system, the instructions being executable by a computer, particularly a data processing unit as described before, and causing, when executed, a machine to:
add a luminescent dye to the fluid, the luminescent dye having a dye specific reflectance and luminescence spectral pattern,
run the system, using the fluid as operating medium, to circulate the dye together with the fluid throughout the system,
illuminate a scene including the system and/or surroundings of the system, preferably under ambient lighting conditions, with an additional light source which is composed of at least two illuminants, by switching between the at least two illuminants, wherein at least one of the two illuminants is based on at least one solid-state system,
measure, by means of a sensor, radiance data of the scene when the scene is illuminated by the light source,
inspect whether the dye specific luminescence spectral pattern is detectable/extractable out of the radiance data of the scene, and
identify a leak of the system in the case that the dye specific luminescence spectral pattern can be detected/extracted out of the radiance data.

The computer program product may further comprise instructions to identify the dye specific luminescence spectral pattern of the at least one dye by matching the extracted/detected dye specific luminescence spectral pattern with luminescence spectral patterns stored in a data storage unit using any number of matching algorithms between the extracted/detected dye specific luminescence spectral pattern and the stored luminescence spectral patterns. The matching algorithms may be chosen from the group comprising at least one of: lowest root mean squared error, lowest mean absolute error, highest coefficient of determination, matching of maximum wavelength value.

The computer program product may further comprise instructions to perform a predefined action, e. g. to output via an output unit, in the case that the dye specific luminescence spectral pattern can be extracted/detected out of the radiance data, a notification of the identified fluid and/or the identified leak of the system.

The present disclosure further refers to a non-transitory computer-readable medium storing instructions that, when executed by one or more processors, cause a machine to:
add a luminescent dye to a fluid, the luminescent dye having a dye specific reflectance and luminescence spectral pattern,
illuminate a scene, preferably under ambient lighting conditions, with an additional light source which is composed of at least two illuminants, by switching between the at least two illuminants, wherein at least one of the two illuminants is based on at least one solid-state system,
measure, by means of a sensor, radiance data of the scene when the scene is illuminated by the light source,
inspect whether the dye specific luminescence spectral pattern is detectable/extractable out of the radiance data of the scene, and
in the case that the dye specific luminescence spectral pattern can be detected/extracted out of the radiance data, to identify the fluid.

In another aspect, the present disclosure refers to a non-transitory computer-readable medium storing instructions that, when executed by one or more processors, cause a machine to:
add a luminescent dye to a fluid, the luminescent dye having a dye specific reflectance and luminescence spectral pattern,
run a system, using the fluid as operating medium, to circulate the dye together with the fluid throughout the system,
illuminate a scene including the system and/or surroundings of the system, preferably under ambient lighting conditions, with an additional light source which is composed of at least two illuminants, by switching between the at least two illuminants, wherein at least one of the two illuminants is based on at least one solid-state system,
measure, by means of a sensor, radiance data of the scene when the scene is illuminated by the light source,
inspect whether the dye specific luminescence spectral pattern is detectable/extractable out of the radiance data of the scene, and
in the case that the dye specific luminescence spectral pattern can be detected/extracted out of the radiance data, to identify a leak of the system.

The terms “data processing unit”, “processor”, “computer” are used synonymously and are to be interpreted broadly.

The invention is further defined in the following examples. It should be understood that these examples, by indicating preferred embodiments of the invention, are given by way of illustration only. From the above discussion and the examples, one skilled in the art can ascertain the essential characteristics of this invention and without departing from the spirit and scope thereof, can make various changes and modifications of the invention to adapt it to various uses and conditions.

### BRIEF DESCRIPTION OF THE DRAWINGS

FIG. 1 shows schematically an embodiment of the proposed device executing an embodiment of the proposed method.

### DETAILED DESCRIPTION OF THE DRAWINGS

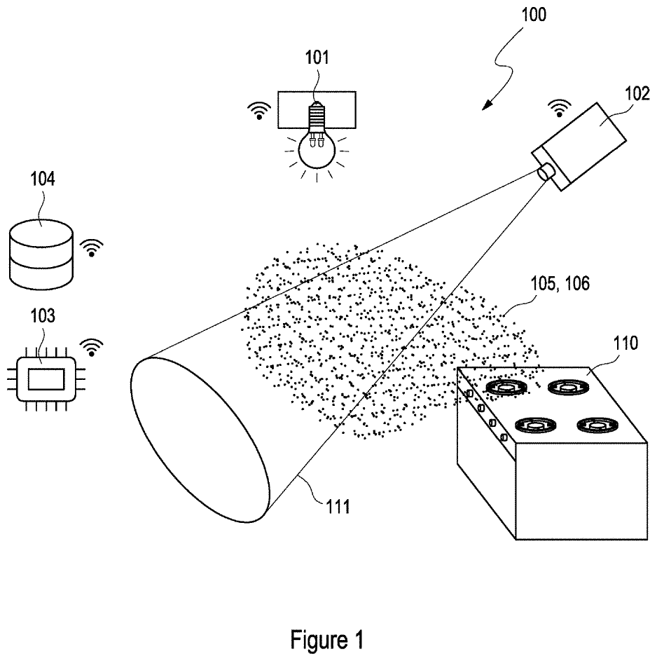

FIG. 1 shows an embodiment of a device 100 for monitoring a system for leaks via a computer vision application. The system is represented here by a stove 110 which uses a fluid, namely a gas 105 as operating medium which is to be carried continuously through pipes of the stove 110. The device 100 for monitoring the stove 110 for leaks comprises a light source 101, a sensor 102, a data storage unit 104 and a data processing unit 103. The device 100 for monitoring the stove 110 for leaks further provides at least one luminescent dye 106, each luminescent dye having dye-specific reflectance and luminescence spectral patterns and being configured to be added to the gas 105. Further, a controller, not shown here, is provided in order to run the stove 110 to circulate the dye when being added to the gas throughout the stove 110, i.e. the pipes of the stove 110. The light source 101 is composed of at least two illuminants and is configured to illuminate a scene including the stove 110 and/or the surroundings of the stove 110 under ambient lighting conditions, by switching between the at least two illuminants wherein at least one of the two illuminants is based on at least one solid-state system. The at least one solid-state system may be chosen from the group of solid-state systems comprising semiconductor light emitting diodes (LEDs), organic light emitting diodes (OLEDs), or polymer light emitting diodes (PLEDs).

The data storage unit 104 stores and provides luminescence spectral patterns together with appropriately assigned respective dyes. The sensor 102 is configured to measure radiance data of the scene when the scene is illuminated by the light source 101. The scene includes here the surroundings of the stove 110, as indicated by the cone 111 (viewing field of the sensor 102) originating from the sensor 102. The sensor 102 is generally an optical sensor with photon counting capabilities. More specifically, it may be a monochrome camera or an RGB camera or a multispectral camera or a hyperspectral camera. The sensor 102 may also be a combination of any of the above, or a combination of any of the above with a tunable or selectable filter set, such as, for example, a monochrome sensor with specific filters. The sensor may measure a single pixel of the scene or measure many pixels at once. The optical sensor 102 may be configured to count photons in a specific range of spectrum, particularly in more than three bands. It may be a camera with multiple pixels for a large field of view, particularly simultaneously reading all bands or different bands at different times. In FIG. 1 the scene is defined by the cone 111 incorporating surroundings of the stove 110.

Up to now, fluorescent leak detection is commonly performed on hydraulic and refrigerant systems to more easily find the source of costly, performance degrading, and environmentally damaging leaks. Typically, a technician adds a fluorescent dye to the respective system, runs the system to circulate the dye throughout the entire system, and then checks the system for leaks by shining an appropriate light source (most often UV or blue light) on components of the system. If the ambient lighting is dark enough, leaks can be easily seen as the fluorescent dye in the system fluid will emit visible light where the leak is occurring. While this method known in the art is effective at finding leaks, it requires the presence of a technician and is not a continuously monitored process. Substantial benefits could be realized if the system is continuously monitored and the leak is automatically detected so appropriate measures, call for maintenance, partial or complete shutdown of the system, etc., could be initiated.

The proposed device according to the present disclosure pairs the technique to separate reflectance and fluorescence emission components under ambient light to automatic fluorescent leak detection. In many cases, systems such as the stove 110 that should be monitored for leaks are in an environment where bright lighting is required for other purposes. While it may be acceptable to temporarily dim these lights for a technician to inspect the system for leaks, continuous dimming of the lights as is currently required for computer vision detection of the fluorescent leak would be unacceptable. Therefore, the proposed device 100 provides the possibility to distinguish fluorescence emission from reflectance under ambient lighting conditions. By means of the proposed device 100 it is possible to match the detected fluorescence emission to a corresponding dye in the data storage unit 104 to facilitate dye identification for computer vision. It is possible that the device further comprises an output unit which is configured to output, in the case that the dye-specific luminescence spectral pattern can be detected out of the radiance data, a notification of the identified leak of the system 110. Such an output can be realized by a display and/or by an acoustic output, such as a loud speaker. It is possible that the device simply sends and/or outputs the signal when a certain level of fluorescence was detected and could be matched to a dye whose fluorescence pattern is stored in the data storage unit 104.

It is further possible that the device provides a plurality of different dyes, the different dyes having different dye-specific reflectance and luminescence spectral patterns and being configured to be added to the fluid in different fluid paths within the system 110, here the stove, thus enabling, in the case that one of the dye-specific luminescence spectral patterns can be detected out of the radiance data, the localization of the identified leak in the stove 110. The data processing unit 103 which matches the detected luminescent/luminescence spectral pattern with luminescence spectral patterns stored together with appropriately assigned respective dyes in the database 103, is configured to identify the dye-specific luminescence spectral pattern of the at least one dye by matching the detected dye-specific luminescence spectral pattern with the luminescence spectral patterns stored in the data storage unit 103 using any number of matching algorithms between the detected dye-specific luminescence spectral pattern and the stored luminescence spectral patterns. The matching algorithms may be chosen from the group comprising at least one of: lowest root means squared error, lowest mean absolute error, highest coefficient of determination, matching of a maximum wavelength value.

Fluorescence leak detection materials for hydraulic and refrigerant systems are already commercially available. It is also possible to monitor gaseous systems with natural gas, propane, ammonia, etc. as operating medium. In this case, suitable fluorophores for the respective gases have to be added.

### LIST OF REFERENCE SIGNS

100 device
101 light source
102 sensor
103 data processing unit, database
104 data storage unit
105 fluid
106 dye
110 system (stove)
111 scene (cone)

1. A device for recognizing and monitoring a fluid in a system and/or in surroundings of the system via a computer vision application, the device comprising at least the following components:
at least one luminescent dye, each luminescent dye having a dye specific reflectance and luminescence spectral pattern and being configured to be added to the fluid,
a light source which is composed of at least two illuminants and which is configured to illuminate a scene which includes the system and/or the surroundings of the system, by switching between the at least two illuminants, wherein at least one of the two illuminants is based on at least one solid-state system,
a sensor which is configured to measure radiance data of the scene when the scene is illuminated by the light source, and
a data processing unit which is configured to determine whether the dye specific luminescence spectral pattern is detectable out of the radiance data of the scene when the scene is illuminated by the light source, and, in the case that the dye specific luminescence spectral pattern can be detected out of the radiance data, to identify the fluid the dye has been added to.

2. The device of claim 1 for monitoring the system for leaks via a computer vision application, the system using the fluid as operating medium which is to be carried continuously through the system, wherein
the data processing unit is configured to determine whether the dye specific luminescence spectral pattern is extractable out of the radiance data of the scene when the scene is illuminated by the light source, and, in the case that the dye specific luminescence spectral pattern can be extracted out of the radiance data, to identify a leak of the system.

3. The device according to claim 1, further comprising an output unit which is configured to perform and/or initiate, in the case that the dye specific luminescence spectral pattern can be extracted out of the radiance data, a predefined action.

4. The device according to claim 1, which comprises a plurality of different dyes, the different dyes having different dye specific reflectance and luminescence spectral patterns and being configured to be added to the fluid in different fluid paths within the system, thus enabling, in the case that one of the dye specific luminescence spectral patterns can be extracted out of the radiance data, a localisation of the identified fluid, particularly of the identified leak in the case that the device is used for leak detection.

5. The device according to claim 1, which comprises a data storage unit with luminescence spectral patterns together with appropriately assigned respective dyes, wherein the data processing unit is configured to identify the dye specific luminescence spectral pattern of the at least one dye by matching the extracted dye specific luminescence spectral pattern with the luminescence spectral patterns stored in the data storage unit using any number of matching algorithms between the extracted dye specific luminescence spectral pattern and the stored luminescence spectral patterns.

6. The device according to claim 1, wherein the sensor is a hyperspectral camera or a multispectral camera.

7. The device according to claim 1, wherein the light source is a switchable light source with two illuminants each comprised of one or more LEDs and with a short switchover time between the two illuminants.

8. The device according to claim 1, wherein the sensor is synchronized to the switching of the light source to only issue at one time the radiance data from the scene and/or the surroundings of the scene under one of the at least two illuminants.

9. A method for recognizing and monitoring a fluid in a system and/or in surroundings of the system via a computer vision application, the method comprising at least the following steps:
admixing a luminescent dye to the fluid, the luminescent dye having a dye specific reflectance and luminescence spectral pattern,
illuminating a scene including the system and/or the surroundings of the system, preferably under ambient lighting conditions, with an additional light source which is composed of at least two illuminants, by switching between the at least two illuminants, wherein at least one of the two illuminants is based on at least one solid-state system,
measuring, by means of a sensor, radiance data of the scene when the scene is illuminated by the light source,
determining, by a data processing unit, whether the dye specific luminescence spectral pattern is detectable out of the radiance data of the scene, and
in the case that the dye specific luminescence spectral pattern can be detected out of the radiance data, identifying, by the data processing unit, the fluid.

10. The method of claim 9 for monitoring the system for leaks via a computer vision application, the system using the fluid as operating medium which is to be carried continuously through the system, the method further comprising at least the following steps:
determining, by the data processing unit, whether the dye specific luminescence spectral pattern is extractable out of the radiance data of the scene, and
in the case that the dye specific luminescence spectral pattern can be extracted out of the radiance data, identifying, by the data processing unit, a leak of the system.

11. The method according to claim 9, further comprising providing a data storage unit with luminescence spectral patterns together with appropriately assigned respective dyes, and identifying the dye specific luminescence spectral pattern of the at least one dye by matching the extracted dye specific luminescence spectral pattern with the luminescence spectral patterns stored in the data storage unit using any number of matching algorithms between the extracted dye specific luminescence spectral pattern and the stored luminescence spectral patterns.

12. The method according to claim 9, further comprising initiating and/or performing, in the case that the dye specific luminescence spectral pattern can be extracted out of the radiance data, a predefined action.

13. The method according to claim 9, wherein a plurality of different dyes is provided, the different dyes having different dye specific reflectance and luminescence spectral patterns, and different dyes are admixed to the fluid in different fluid paths within the system, thus enabling, in the case that one of the dye specific luminescence spectral patterns can be extracted out of the radiance data, a localisation of the identified fluid.

14. The method according to claim 9, wherein the light source is chosen as a switchable light source with two illuminants each comprised of one or more LEDs and with a short switchover time between the two illuminants.

15. A computer program product having instructions for monitoring a fluid in a system and/or in surroundings of the system via a computer vision application, wherein the instructions are stored on a non-transitory computer-readable medium functionally coupled to one or more processors and cause, when executed on the one or more processors, a machine to:
admix a luminescent dye to the fluid, the luminescent dye having a dye specific reflectance and luminescence spectral pattern,
illuminate a scene which includes the system and/or the surroundings of the system, preferably under ambient lighting conditions, with an additional light source which is composed of at least two illuminants, by switching between the at least two illuminants, wherein at least one of the two illuminants is based on at least one solid-state system,
measure, by means of a sensor, radiance data of the scene when the scene is illuminated by the light source,
determine, by a data processing unit, whether the dye specific luminescence spectral pattern is detectable out of the radiance data of the scene, and
in the case that the dye specific luminescence spectral pattern can be detected out of the radiance data, identifying, by the data processing unit, the fluid.
